(19) United States
(12) Patent Application Publication
(10) Pub. No.: US 2023/0281570 A1
(43) Pub. Date: Sep. 7, 2023

(54) SYSTEM AND METHOD FOR MANAGEMENT OF RESOURCES ASSOCIATED WITH A PHYSICAL ASSET

(71) Applicant: CASALOGY, LLC, Austin, TX (US)

(72) Inventor: Stephen Vigil, Austin, TX (US)

(21) Appl. No.: 17/968,377

(22) Filed: Oct. 18, 2022

Related U.S. Application Data
(60) Provisional application No. 63/257,380, filed on Oct. 19, 2021.

(51) Int. Cl. G06Q 10/20; G06Q 30/0601

(52) U.S. Cl. CPC G06Q 10/20; G06Q 30/0643

(57) ABSTRACT

Systems and methods for managing resources associated with a physical asset including an interactive platform that collects information and maintains a list of resources associated with a physical asset, collects data on the working status of each of the resources regularly, performs a diagnosis to identify a potential issue with a resource, assist a user in forming a context-aware search query related to the potential issue, retrieved a set of contents and provides personalized results suitable for maintaining the resource. In an embodiment, the system, through its unified platform, enables different stack-holders to share information and collaborate in order to maintain the resources. The system helps manage the resources, allows users to connect with other entities having similar resources, and allows users to connect with product or service companies or individuals who can help resolve any identified issue. The system enables residents to connects, collaborate and manage resources efficiently.

The present application claims the benefit of U.S. Provisional Application No. 63/257,380, filed Oct. 19, 2021; all of which is incorporated herein by reference.

### FIELD OF THE DISCLOSURE

Embodiments of the present invention generally relate to the management of resources. In particular, embodiments of the present invention relate to an interactive system to perform predictive diagnostics and assist in managing or maintaining resources associated with a physical asset.

### BACKGROUND OF THE DISCLOSURE

A physical asset, which may be an individual, a house, a commercial establishment, a community, or the likes, may have several resources that need regular service or maintenance. For example, a home may have several resources, such as electrical appliances, mechanical components, HVAC systems, etc., that need to be maintained regularly. Similarly, a community may have several resources, such as central electrical supply, water supply system, drainage system, central HVAC system, etc., that need to be maintained regularly. A typical consumer's home contains or is made up of various structural elements, appliances, equipment, fixtures, furniture, and the like (collectively referred to as resources), all of which are subject to potential problems and may be in need of repair from time to time. A person responsible for managing these resources, referred hereto as a user, may have to keep monitoring the functioning of these resources, track their performance parameters, and if something adverse happens, call for help to fix and maintain these resources.

When something breaks or doesn't perform optimally, a user searches typically on the Internet for information on how to fix it, look for professional services, search for the places to get the required components or services and call them. There are multiple steps involved, and each of these steps has inherence inefficiency. For example, if the user needs help fixing an HVAC system, the user needs to know which component of the system is creating the issue and look for help specifically related to that component. However, most of the time, users will not know the component details and may not even be aware of the brand of installed resources. The existing process of searching, calling customer support, identifying the service center, navigating to the service center, etc., are fragmented and inefficient ways of maintaining the resources. The user may not know what issue required what level of attention, whether the issue can be fixed through little educational or do-it-yourself videos, or it requires expert intervention.

There are some existing platforms that provide a listing of service person contact details, navigation to the service center, etc. There are video platforms that provide the do-it-yourself type of video, which might be helpful to resolve the issue. But, these platforms are very generic in nature and provide the same results to all the users who search for help on similar topics. A user may spend time viewing several videos and may end up disappointed to find that none of these videos is helpful as the video is not talking specifically about the issue where the user needs help.

Some of these issues are being addressed with changing legal framework. For example, a real-estate builder is required to give an instruction manual, warranty papers, etc., to the owner of a property for maintaining resources used in the property. However, these manuals are mostly paper booklets and have static contents. These instruction manuals get misplaced very often and may not be readily available when required. Even when digitized, their content is static and may not be very useful for users. Different users may have different levels of skills and hence may need a different level of details or help when they face an issue.

Some attempts have been made in the past to solve some of the related problems discussed above. An example is disclosed in the United States Patent Publication No. 2020/0342421 titled “Home maintenance and repair information technology methods and systems” (the “'421 publication”). The '421 Publication discloses methods and systems for enabling a host provider to provide a consumer homeowner with improved maintenance and repair services for items in the home, including under a subscription model that provides the consumer with predictable cost while assuring reliable services. The '421 Publication discloses an overall information technology system, with interrelated modules and components for enabling a host to facilitate the provision of home maintenance and repair services to a consumer.

The methods and systems disclosed herein include an item scoring module for scoring at least one item based on its type, the score based at least in part on a probability of a need for maintenance or repair, and the estimated cost of such maintenance or repair. The system includes a service provider scoring module for scoring at least one service provider based on at least one of the quality of maintenance or repairs provided by the service provider, the availability of the service provider, the reliability of the service provider, and the cost of the service provider, and a pricing module for estimating the cost of providing a commitment to provide long term maintenance and repairs for the at least one scored item using at least one scored service provider.

The methods and systems include a consumer communication module, such as allowing communication to a consumer using various interfaces. The consumer communication module includes a scheduling module, a cost estimation module, a gamification module, and a coordination module. The system further includes a service fulfillment module. In embodiments, the service fulfillment module is used to select a service provider for fulfillment based at least in part on the service provider scoring module. The proposed methods and systems fail to recognize the actual needs of the user and the level of support that the user needs.

Another example solution is disclosed in the United States Patent publication no. 2020/0134752 titled “House Hub” (the “'752 Publication”). The '752 Publication discloses a method and system for providing maintenance services. The system receives user credentials from at least one user, authenticates at least one user based on the user credentials, receives item information related to property from at least one user, generates at least one notification based on at least one item information related to the property, and provides at least one service to the user based on the at least one item information related to the property. The proposed methods and systems fail to recognize the specific needs of the user. Also, the item information needs to be provided by the user.

Another example is disclosed in United States Patent Publication No. 2011/0270773 titled “Home maintenance recommendation tool” (the “'773 Publication”). The '773 Publication discloses Embodiments of the present invention provide a home maintenance recommendation tool that is incorporated into a user's online financial account. The home maintenance recommendation tool generally provides a user the ability to review, edit, submit and track home maintenance repairs needed on one or more properties owned by the user. The home maintenance recommendation tool receives information related to repairs that the property might need through the information that is captured when the mortgage is originated, purchased, or serviced, or through purchases made by the user at a business using certain financial accounts. The home maintenance recommendation tool also provides the user the ability to search, identify, receive, and purchase products and services needed to make the suggested repairs through businesses that are strategic partners with the financial institution using the user's online financial account.

All these existing solutions allow a user to search, identify and receive products and services through an online platform. However, none of these systems recognized the specific needs of the user, understand the level of support that a user needs, and provide a personalized information dashboard to manage the resources. The search feature provided is generic, and hence the results displayed are not always useful.

Therefore, there is a need for a method, system, and platform that can understand the maintenance need for resources associated with the entity, enable assisted searching to retrieve the right content, help users get the required level of support, and present personalized content.

The present disclosure makes possible a number of the needed solutions and makes a material and substantial improvement to the current state of the art for understanding maintenance needs for resources associated with the entity, help the user get the required level of support, and present personalized contents.

### BRIEF SUMMARY OF THE DISCLOSURE

Systems and methods for managing resources associated with a physical asset are described. According to an embodiment, the system includes an interactive platform that collects information and maintains a list of resources associated with a physical asset, collects data on the working status of each of the resources regularly, performs a diagnosis to identify a potential issue with a resource, assist a user in forming a context-aware search query related to the potential issue, retrieved a set of contents and provides personalized results suitable for maintaining the resource. The system performs predictive diagnosis or performs the diagnosis when an issue is reported.

In an embodiment, the system can assist the user form the context-aware search query based on collected data or reported data. The context-aware search query includes identification of components, bug code (if any), model number, and similar other information used to precisely identify the issue. In an embodiment, the system helps the user form a context-aware query or add context to a query submitted by the user automatically based on the collected data about the issue. A query formation module associated with the system can take voice, text, or image query from the user, identify the relevant keywords from the user query and add other context-aware data to form the context-aware query that can be submitted to a search engine. The query formation module can extract and highlight one or more resources that might have created the issue based on other data collected from resources when a user clicks a photo or select an image. The system uses automatically collected data to highlight one or more resources that might be facing an issue and allow a user to select one resource for getting further help. An object recognization and extraction module of the system uses image processing to identify different resources and highlight one or more resources based on analyzed anamoly in collected data.

In an embodiment, the system considers user proficiency related to identified issues and presents the personalized search results accordingly. The system provides personalized search results and content (also referred to as recommended content) using a machine learning model that can predict content and metadata that may be useful for resolving the identified issue. The system trains the model with earlier reported issues and what details were useful to what kind of users. The system recommends the content based on the profile match of the user with other users and the identified issue with earlier identified issues in the past. For example, the system for an HVAC related issue can identify the recommended content (e.g., do-it-yourself video, contact detail of service person, instruction manual, etc.) based on historical training on what kind of content was helpful for other residents in the same community having similar house layout, or house constructed by the same build or using the same service provider.

In an embodiment, the system, through its unified platform, enables different stack-holders to share information and collaborate in order to maintain the resources. The system helps manage the resources, allows users to connect with other entities having similar resources, and allows users to connect with product or service companies or individuals who can help resolve any identified issue. The system enables residents to connects, collaborate and manage resources efficiently. The system helps present the issue precisely to technicians or engineers working to fix the identified issue. Different stack holders can access the system using user devices online.

In an embodiment, the unified platform allows users to order components or book services for the identified issue. The platform may present contact details, demo videos, instruction manuals, warranty papers, etc., that the user may need to resolve the identified issue. Instead of presenting all available content, the system intelligently selects the content to present the user based on the profile of the user and the identified issue.

In an embodiment, the system allows real estate developers to share details of resources, required documents, instruction manuals, warranties through a single. The new owner can access the list of the resources and associated details through a web-based interface or mobile App. The system will auto-populate the list of resources to the dashboard of a new owner when the property transaction is completed. The system allows a new owner to search the list of resources and associated details by entering property ID. For example, a user can get to know the details on electrical fitting, HVAC systems, appliances, exterior, interior, plumbing, etc., by entering the unique ID of the home.

In an embodiment, the system includes an eCommerce module that recommends content to homeowners specific to their house. The system, through data analysis, can identify the need of the home and recommend the content to the homeowner. The system can help a homeowner improve and maintain their home faster, better by qualified industry professionals. The system facilitates a marketplace where the professional distributor and professional service provider can list their services for specific home type, resource type, brand, etc. The professional distributor and professional service provider (collectively referred to as Pro distributor) can upload instruction manual, videos, diagnostic steps, etc. The professional distributor or service professional can add, manage, collect and publish web links. The professional distributor or service professional can bulk upload the contents, which the system can classify can tag with different issues that it can help resolve. The professional distributor or service professional can add his details against one or more property types (for example, properties developed by a particular real estate developer) or product types. The system may connect the user with the right Pro distributor or service provider.

The system auto categorizes the resources into different groups intelligently and presents the category options depending on the entity type selected by the user. For example, the broader category for entity type “home” includes HVAC, Appliances, Exterior, Plumbing, Electrical, etc. In proposed system provides a better searching experience, presents the best matching content, and provides product and service recommendations. The system may present alerts, tips, events, and special offers useful for maintaining the resources. The system helps the user easily find the documents, instruction manuals, and contact details of the professional distributor or service professional.

The system may provide home improvement recommendations to homeowners. The system provides home improvement recommendations based on the collected data, complementary products and services related to existing products or services, and analysis of user activity on the platform.

In an embodiment, the system matches homeowners to home-specific online content and businesses to improve and maintain their homes faster, better, with content qualified by industry professionals. Industry professionals can offer solutions to homeowners through the platform. The system allows professionals to maintain personalized pages and Apps through which they can connect with homeowners. The system allows professionals to provide platform branded services or ‘Whitelabel’ services through a standard version of App or customed App.

Other features of embodiments of the present disclosure will be apparent from the accompanying drawings and detailed description that follows.

### BRIEF DESCRIPTION OF THE DRAWINGS

The present subject matter will now be described in detail with reference to the drawings, which are provided as illustrative examples of the subject matter so as to enable those skilled in the art to practice the subject matter. It will be noted that throughout the appended drawings, features are identified by reference numerals. Notably, the FIGUREs and examples are not meant to limit the scope of the present subject matter to a single embodiment, but other embodiments are possible by way of interchange of some or all of the described or illustrated elements and, further, wherein:

FIG. 1 is a high-level block diagram illustrating a resource management system that supports engagement between different stakeholders in accordance with an embodiment of the present disclosure.

FIG. 2 illustrates functional modules of a resource management system in accordance with an embodiment of the present disclosure.

FIG. 3A illustrates an exemplary entity-specific user interface in accordance with an embodiment of the present disclosure.

FIG. 3B illustrates an example professional distributor interface designed in accordance with an embodiment of the present disclosure.

FIG. 4 illustrates an example process flow enabling a user to select a resource and connect with the right person or business in accordance with an embodiment of the present disclosure.

FIG. 5 illustrates functional blocks of the searching module designed to enable context-aware search query formation and retrieval of recommended content in accordance with an embodiment of the present disclosure.

FIG. 6 is an exemplary block diagram illustrating an image-based search feature in accordance with an embodiment of the present disclosure.

FIG. 7 is an exemplary block diagram illustrating text or voice-based search feature in accordance with an embodiment of the present disclosure.

FIG. 8 illustrates an example feature list offered through a mobile application by the system to a user in accordance with an embodiment of the present disclosure.

FIG. 9 is a flow diagram illustrating image-based interaction with the system in accordance with an embodiment of the present disclosure.

FIG. 10A is an example user interface illustrating a landing page for a mobile application in accordance with an embodiment of the present disclosure.

FIG. 10B is an example user interface illustrating categories for selected entity types in accordance with an embodiment of the present disclosure.

FIG. 10C is an example user interface illustrating a sub-category of resources in accordance with an embodiment of the present disclosure.

FIG. 10D is an example user interface illustrating item types associated with a resource that a user can browse in accordance with an embodiment of the present disclosure.

FIGS. 11A-11C are example user interfaces illustrating different content types that can be shown to the user in accordance with an embodiment of the present disclosure.

FIGS. 12A-C are example user interfaces used to add details associated with a resource in accordance with an embodiment of the present disclosure.

FIG. 13 illustrates an exemplary computer system in which or with which embodiments of the present invention may be utilized.

### DETAILED DESCRIPTION OF THE EMBODIMENTS

The detailed description set forth below in connection with the appended drawings is intended as a description of exemplary embodiments in which the presently disclosed process can be practiced. The term “exemplary” used throughout this description means “serving as an example, instance, or illustration” and should not necessarily be construed as preferred or advantageous over other embodiments. The detailed description includes specific details for providing a thorough understanding of the presently disclosed method and system. However, it will be apparent to those skilled in the art that the presently disclosed process may be practiced without these specific details. In some instances, well-known structures and devices are shown in block diagram form in order to avoid obscuring the concepts of the presently disclosed method and system.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and human operators.

Embodiments of the present invention may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within the single computer) and storage systems containing or having network access to a computer program(s) coded in accordance with various methods described herein, and the method steps of the invention could be accomplished by modules, routines, subroutines, or subparts of a computer program product.

The terms “connected” or “coupled” and related terms are used in an operational sense and are not necessarily limited to a direct connection or coupling. Thus, for example, two devices may be coupled directly or via one or more intermediary media or devices. As another example, devices may be coupled in such a way that information can be passed therebetween while not sharing any physical connection with one another. Based on the disclosure provided herein, one of ordinary skill in the art will appreciate a variety of ways in which connection or coupling exists in accordance with the aforementioned definition.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

As used herein, a “network resource” generally refers to various forms of data, information, services, applications, and/or hardware devices that may be accessed via a network (e.g., the Internet). Non-limiting examples of network resources include web applications, cloud-based services, networked devices and/or associated applications (e.g., user interface applications), and network security devices and/or associated applications (e.g., user interface applications). Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this invention will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

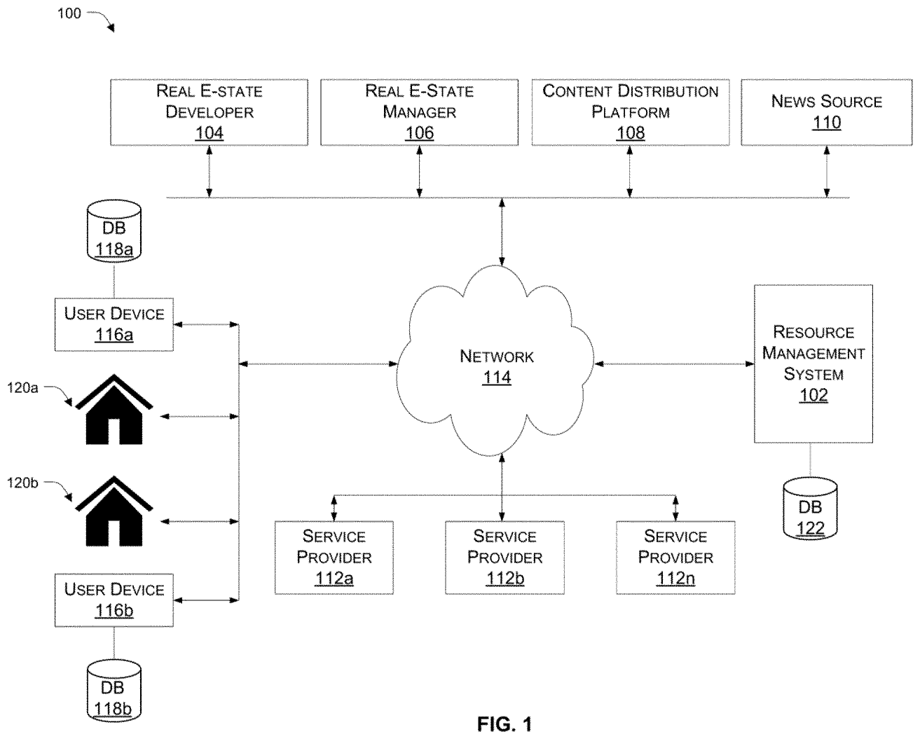

FIG. 1 is a high-level block diagram illustrating a resource management system that supports engagement between different stakeholders in accordance with an embodiment of the present disclosure. The resource management system 102 maintains a central database (e.g., DB 122) or uses cloud storage to store a profile of entities (e.g., individual user, home, community, company, etc.), service providers, original equipment manufacturers, real-real developers, etc. and enable interaction between different stakeholders when needed. A system 102 maintains a list of resources associated with each entity(e.g., home 120a, home 120b, individual, community, company, etc.). A user using a user device (e.g., user device 116a, and user device 116b) can connect with the resource management system 102 through network 114. A user using a mobile application or web-based interface can search with a physical asset identification number (e.g., house number, society registration number, SSN, etc.) and get details of all resources associated with a physical asset. System 102 allows an application running on a user device to store details associated with the resources on a local database (e.g., DB 118a associated with user device 116a and DB 118b associated with user device 116b) for better privacy protection or can store the list of resources belonging to a physical asset in a central database 122 or cloud-based database.

While most social apps have business models that are based on extracting targeted user data to send targeted advertisements and sell user information, system 102 doesn't require users to disclose any personally identifiable information to sign up. System 102 supports target ads on aggregate trends in interactions based on the home profile, as well as the community as a whole, but not the individual user. By default, saved information is stored only specific to the device and is saved to the device using a local database. This architecture allows even children to contribute anonymously and effectively. Users can access the system using a home id specific to the home, not the resident. Users can add and save private content items by saving them to a device-specific local database (Local Storage) for later retrieval. This creates a means for users to save a reference to their favorite items without having to sign up or save items to the web. This is key for safely allowing all ages to use. Users can share an individual item or a filtered list of items, including favorites.

A user can enter a physical asset identification number, authenticate himself to access resource details associated with the entity, and can access the list of resources once authenticated. System 102 may present a list of resources associated with the entity, working status of resources, data collected from Internet-enabled resources, and analyze the collected data to identify a potential issue. System 102 may perform predictive diagnostics on all resources regularly or perform resource-specific diagnostics on request of the user. A user may browse through the list of resources associated with a physical asset and select a resource to get more detail. The list of resources associated with the entity can be bulk uploaded through a smart script or can be uploaded through a web-based or mobile application interface. In an embodiment, a new resource can be automatically be associated with a physical asset when purchase and installation are confirmed. For example, a new appliance can be added to the list of resources associated with a home when the purchase and installation at home are confirmed.

The system allows different stakeholders to post content related to different resources, tag it appropriately, and upload it for access by other users. Different stakeholders include end-users, homeowners, real estate developers 104, real estate manager 106, content developers, news resources 110, service providers 112a-n, original equipment manufacturers (OEMs), authorized distributors, authorized service centers, and the like. The uploaded content can be stored in database DB 122 managed by system 102 or be uploaded to content distribution platform 108. In an embodiment, system 102 for memory optimization may store raw media files on the content distribution platforms(e.g., youtube) and keep the manifest file or the metadata information on the location DB 122.

System 102 enables the transfer of access rights to get details on the list of resources associated with a home (e.g., home 120a) when the real-estate developer 104 sells the home to a new homeowner. The Dashboard board of the homeowner will auto-populate the list of resources associated with the home. The homeowner can browse through the list of resources, select a resource to get details, such as OEM, brand, model number, purchase date, installation date, working status, warranty document, next service due date, etc.

System 102 regularly collects data on the working status of each of the resources and performs a diagnosis to identify a potential issue with a resource. System 102 assists a user in forming a context-aware search query related to the potential issue, retrieved a set of contents, and provides personalized results suitable for maintaining the resource.

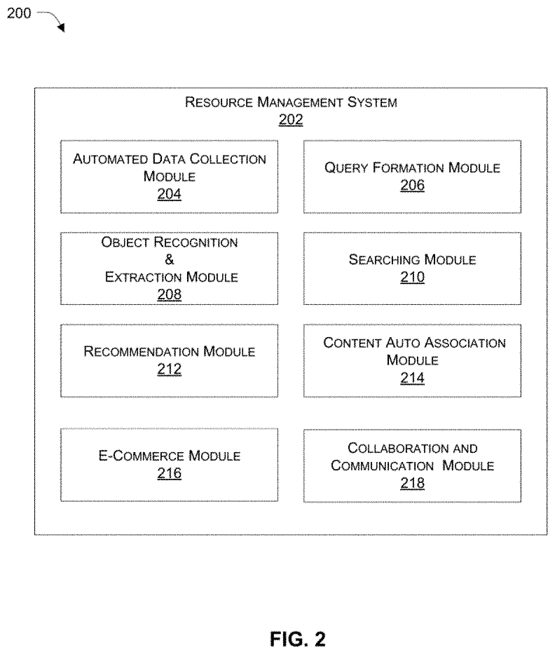

FIG. 2 illustrates functional modules of a resource management system in accordance with an embodiment of the present disclosure. The resource management system 202 (same as system 102) includes an automatic data collection module 204 that can collect logs and working status data from Internet-enabled resources. The automatic data collection module 204 helps retrieve identification details of a new resource associated with a physical asset and collect metadata from public sources, warranty certificates from the seller, and annotate content using different Application Program Interfaces (APIs). The data collection 202 receives through a push or pull mechanism log data and working status data and bug code (if any generated) from resources through a wireless or wired interface.

System 202 includes a query formation module 206 that helps the user generate context-aware queries when the user needs helps in managing or improving resources. Module 206 can assist the user from the context-aware search query based on collected data or reported data. The context-aware search query includes identification of components, bug code (if any), model number, and similar other information used to precisely identify the issue. In an embodiment, module 206 helps the user form a context-aware query or add context to a query submitted by the user automatically based on the collected data about the issue. The query formation module 206 can take voice, text, or image query from the user, identify the relevant keywords from the user query and add other context-aware data to form the context-aware query that can be submitted to a search engine. The query formation module 206 can also receive the image-based search request.

Module 206 works with object recognization and extraction module 208 that is configured to perform image analysis, detect an object and extract objects for performing the search. Module 208 can provide text or an extracted object that can be used for searching. The query formation module 206 helps select an object from a list of the object recognized by module 208. For example, the query formation module 206 can pass information to the image analysis engine to bias itself to recognize resources for which collected data shows some anamoly. Module 208 may help to select an object and highlight one or more resources that might have created the issue based on other data collected from resources when a user clicks a photo or select an image. Module 208 use collected data to highlight one or more resources that might be facing an issue and allow a user to select one resource for getting further help. An object recognization and extraction module 208 of the system uses image processing to identify different resources and highlight one or more resources based on analyzed anamoly in collected data.

System 202 includes a searching module 210 that receives a context-aware search query and submits the query for one or more search engines and to its internal database to identify matching results. The searching module 210 retrieved a list of matching results and pass the results summary and annotated data to recommendation module 212. The recommendation module 212 of system 202 considers user proficiency related to identified issues and presents the personalized search results accordingly. The recommendation module 212 provides personalized search results and content (also referred to as recommended content) using a machine learning model that can predict content and metadata that may be useful for resolving the identified issue. Module 212 used a machine learning model that is trained with earlier reported issues and what details were useful to what kind of users. The recommendation module 212 recommended the content based on profile match of the user with other users and identified an issue with earlier identified issues in the past. For example, the recommendation module 212, for an HVAC related issue, can identify the recommended content (e.g., do-it-yourself video, contact detail of service person, instruction manual, etc.) based on historical training on what kind of content was helpful for other residents in the same community having similar house layout, or house constructed by the same build or using the same service provider.

In an embodiment, system 202, through its unified online platform, enables different stack-holders to share information and collaborate in order to maintain the resources. System 202 helps manage the resources, allows users to connect with other entities having similar resources, and allows users to connect with product or service companies or individuals who can help resolve any identified issue. The system enables residents to connects, collaborate and manage resources efficiently. The system helps present the issue precisely to technicians or engineers working to fix the identified issue. Different stack holders can access the system using user devices online.

The platform enables residents and residential communities to connect with resources to improve and manage their homes, environment, and lifestyle. The platform allows distributors to leverage their local community, residents, and local businesses to contribute ecosystem of the system-supported apps. The platform enables referrals to local entertainment, news & activities.

While there are many home management apps that focus on simply maintaining and improving your home and property by offering a database to find home improvement resources quickly, the proposed system aims to improve the community as a whole by offering interactive tools that help educate, communicate and collaborate. The proposed system utilizes web technologies to manage and prefilter content submitted by different users. The system supports multiple options to find content, including a general menu. The general menu includes links to categories for each main feature of the home, along with its corresponding sub-features.

In an embodiment, the unified platform allows users to order components or book services for the identified issue. The platform may present contact details, demo videos, instruction manuals, warranty papers, etc., that the user may need to resolve the identified issue. Instead of presenting all available content, the system intelligently selects the content to present the user based on the profile of the user and the identified issue.

In an embodiment, the system allows real estate developers to share details of resources, required documents, instruction manuals, warranties through a single. The new owner can access the list of the resources and associated details through a web-based interface or mobile App. The system will auto-populate the list of resources to the dashboard of a new owner when the property transaction is completed. The system allows a new owner to search the list of resources and associated details by entering property ID. For example, a user can get to know the details on electrical fitting, HVAC systems, appliances, exterior, interior, plumbing, etc., by entering the unique ID of the home. The system can be accessed through a website, web widget on affiliate websites, or integrated into a downloadable app of a mobile device.

System 202 includes a content auto association module 214 that keeps collecting content associated with any resources that are submitted on different content distribution or social media platforms and tag with the right resource if a suitable match is found. For example, if the content is posted on fixing a refrigerator, the content auto association module 214 will analyze the posted content to identify the brand and model and tag the content with that refrigerator model. All the homeowners who have the same refrigerator model can see the new content. The newly added content can be recommended to a user who is facing a similar issue being addressed in the content.

In an embodiment, the system includes an eCommerce module 216 that recommends content to homeowners specific to their house. Module 216, through data analysis, can identify the need of the home and recommend the content to the homeowner. System 202 can help a homeowner improve and maintain their home faster, better by qualified industry professionals. The system may provide home improvement recommendations to homeowners. The system provides home improvement recommendations based on the collected data, complementary products and services related to existing products or services, and analysis of user activity on the platform.

System 202 facilitates a marketplace where the professional distributor and professional service provider can list their services for specific home type, resource type, brand, etc. The professional distributor and professional service provider (collectively referred to as Pro distributor) can upload instruction manual, videos, diagnostic steps, etc. The professional distributor or service professional can add, manage, collect and publish web links. The professional distributor or service professional can bulk upload the contents, which the system can classify can tag with different issues that it can help resolve. The professional distributor or service professional can add his details against one or more property types (for example, properties developed by a particular real estate developer) or product types. The system may connect the user with the right Pro distributor or service provider.

The system auto categorizes the resources into different groups intelligently and presents the category options depending on the entity type selected by the user. For example, the broader category for entity type “home” includes HVAC, Appliances, Exterior, Plumbing, Electrical, etc. In proposed system provides a better searching experience, presents the best matching content, and provides product and service recommendations. The system may present alerts, tips, events, and special offers useful for maintaining the resources. The system helps the user easily find the documents, instruction manuals, and contact details of the professional distributor or service professional.

The system includes a collaboration and communication module 218 that allows different stack holders to collaborate and communicate on some common issues. For example, module 218 may connect user A and user B, who may be facing a similar issue, and further connect them to a service person. Module 218 enables collaboration and communication to bring stakeholders on a single platform. For example, module 218 may enable collaboration and communication between real-estate builders, homeowners, service providers, community managers, etc.

The system may allow residents of a community to share ideas with others and report issues. In an embodiment, the system may reward users who report a valid issue and post a useful solution that might be useful for others.

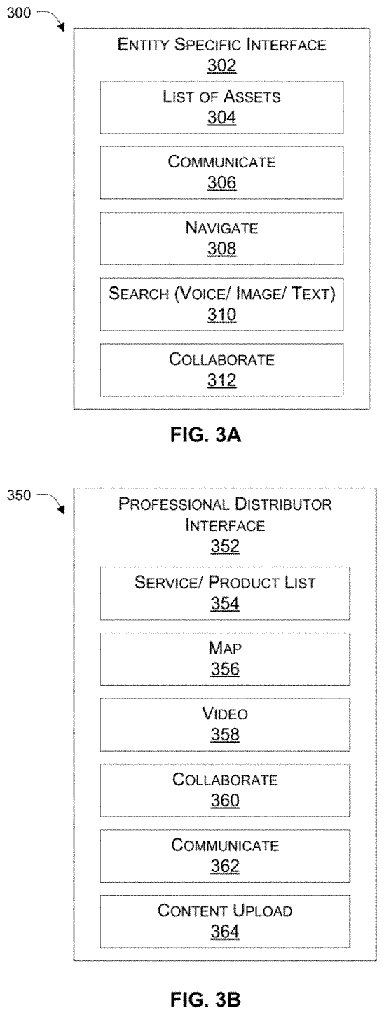

FIG. 3A illustrates an exemplary entity-specific user interface in accordance with an embodiment of the present disclosure. The proposed system may allow stakeholders to connect through custom interfaces. For example, different interfaces for a home owner, professional distributor, or service provider can be provided. The entity-specific interface 302 is an example interface that enables a homeowner to perform different functions enabled by the system. Interface 302 presents a list of resources associated with a physical asset when the user selects option “list of assets 304” (interchangeably referred to as resources). The interface allows the user to communicate with other stakeholders by selecting the option “communicate 306”. On selecting communicate option, the system automatically connects the user with the right person who can help the user solve the issue at hand. The system intelligently selects a person who can help the user based on predictive analysis of the issue being faced. Depending on the level of expertise needed to solve the issue, the system can connect the user to the right person. The user may choose the option “navigate 308” to navigate to the nearest professional distributor or service provider. The user can select the “search 310” option to get help on any issue. As described earlier, on the selection of search options, the system helps the user build context-aware search queries. The interface 302 further includes an option to collaborate 312 that allows different stack holders to share information and collaborate to collectively solve an issue at hand.

FIG. 3B illustrates an example professional distributor interface designed in accordance with an embodiment of the present disclosure. The professional distributor interface 352 is an example interface presented to a professional distributor. The interface allows the professional distributor to see and update service/product list 354 for which he/she is an expert. The professional distributor can select option “map 356” to update or share his location or navigate to the user location from where the issue has been reported. The professional distributor can add/add video related to a resource(product or service) by selecting option “video 358”. The interface also includes options to collaborate 360 and communicate 362 that allows the professional distributor to collaborate and communicate with other stakeholders. The professional distributor interface 352 also includes the option of “content upload 364,” which allows content with annotation/metadata. The annotation or meta data helps search engines to present the matching content to the users.

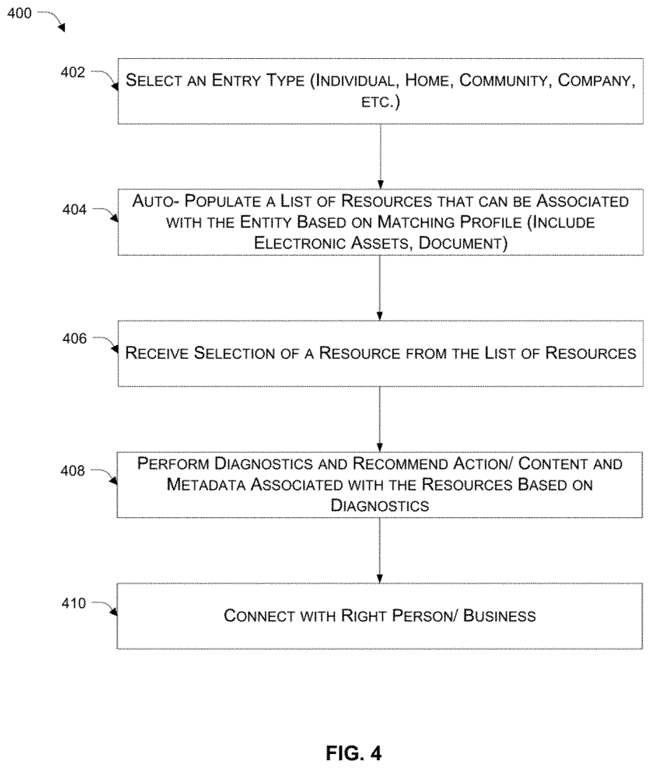

FIG. 4 illustrates an example process flow enabling a user to select a resource-creating issue and connect with the right person or business in accordance with an embodiment of the present disclosure. Process 400 includes steps of enabling a user to select a physical asset type through an application interface, as shown in block 402. The user, through an application interface or web-based interface, may connect to an online resource management platform. The user may select a physical asset type from a list of entity types, which include individual, home, community, company, etc., and enter a physical asset identification number. On entering the entity identification, the user may be promoted to validate its identity if the preconfigured setting of the entity requires so. Process 404 includes steps of auto-populating, by the online resource management platform, a list of resources that can be associated with the entity based on matching profile, as shown at block 404, and enabling the user to select one or more resources from a list of auto-populated resources that the user wishes to manage or improve, as shown at block 406. Process 400 includes steps of performing diagnostics and recommend action or content and metadata associated with resources based on diagnostics, as shown in block 408, and connecting the user with the right person or business as shown in block 410. The user can seek help on any specific resource. For getting help, the user may search for the relevant content on the web, which may be a time-consuming activity. The platform enables a user to perform context-aware searches using text, voice, or image.

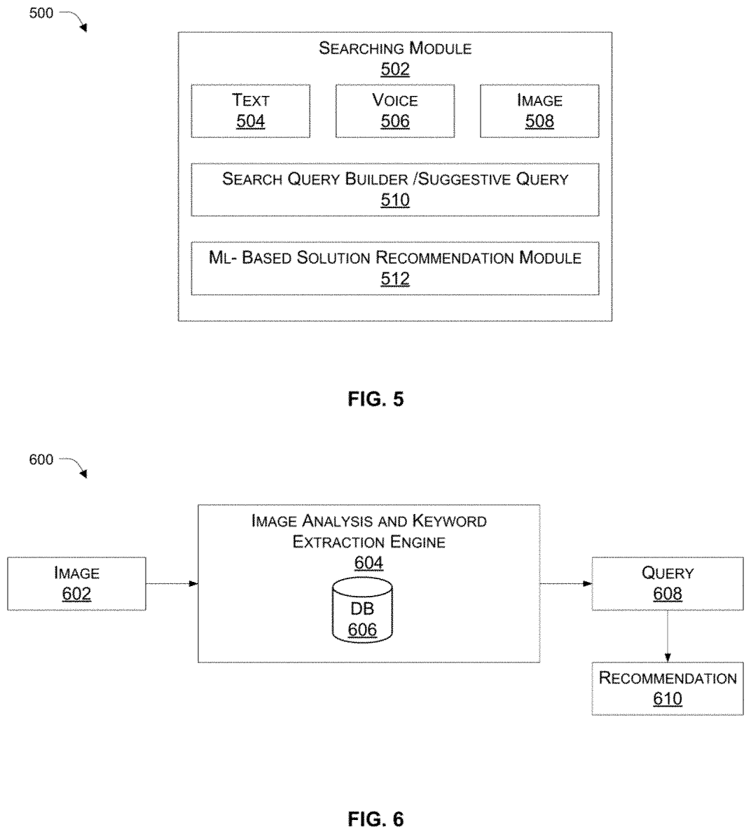

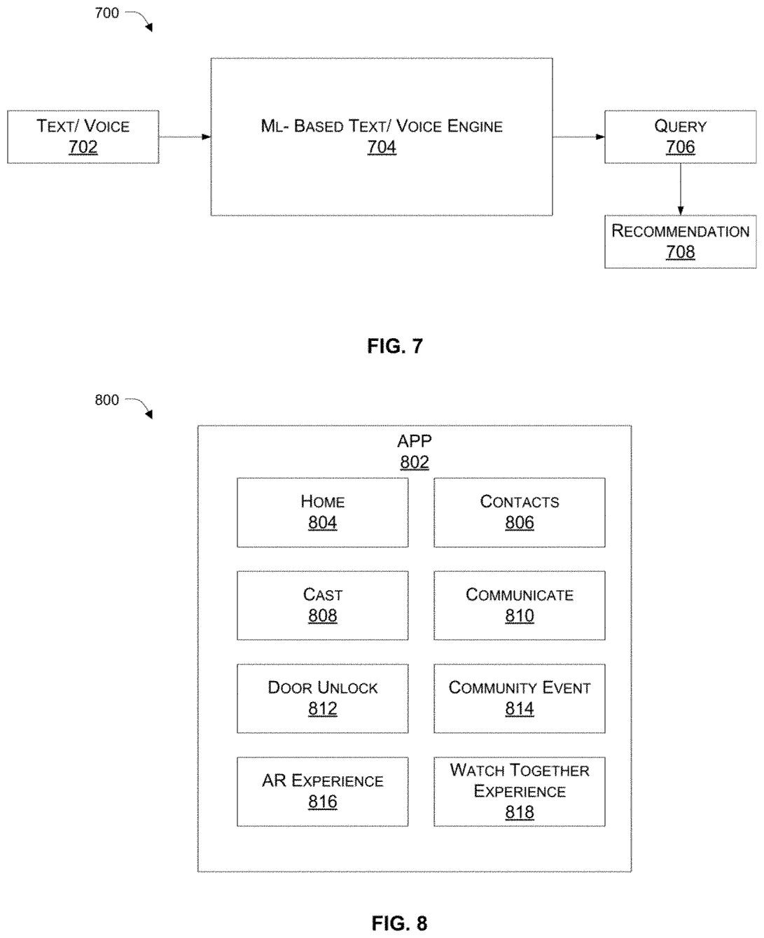

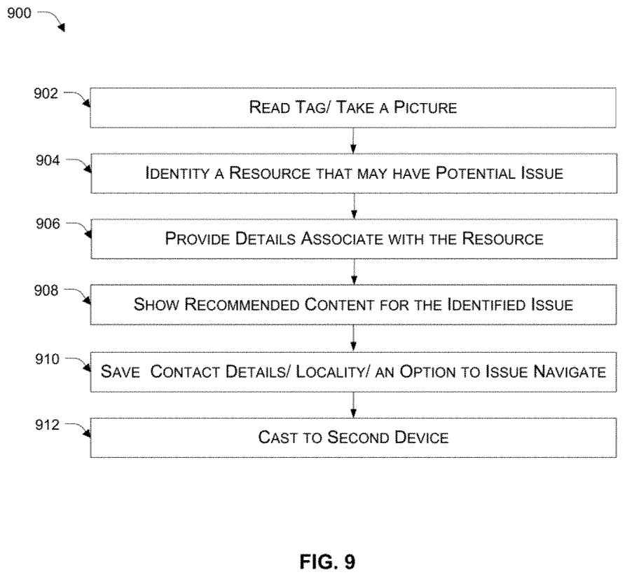

FIG. 5 illustrates functional blocks of the searching module designed to enable context-aware search query formation and retrieval of recommended content in accordance with an embodiment of the present disclosure. The searching module 502 (same as 210) allows users to perform different types of searches, including text 504, voice 506, and image 508. The searching module receives any or combination of text, voice, and image as input and helps to build context-aware search queries. The searching module 502 adds context to the query based on the data collected from resources. A search query builder/suggestive query module 510 helps the user build a context-aware query or provide suggestive query based on user-entered search parameters and data collected from resources. Processing of different types of searches is described later with reference to FIG. 6 and FIG. 7. An ML-based solution recommendation module 512 recommends the best solution and content to the user using a machine learning (ML) model. Module 512 present the recommended solution and content to a user-based submitted context-aware query and the profile of the user. Module 512 considers the type of solutions that were helpful for other users having matching profiles for similar situations/issues.

The searching module 502 helps users query a centralized database of linked content and anonymized resident reviews. The machine learning model helps make predictions of the issue and suitable solutions over time as more data gets added. The model can be trained with data related to more home types, resources, user profiles, contents, issues, and solutions.

There are several way user can submit a query. FIG. 6 is an exemplary block diagram illustrating an image-based search feature in accordance with an embodiment of the present disclosure. As shown in FIG. 6, the user can submit an image 602 that will be processed by image analysis and keyword extraction engine 604. Engine 604 may refer to local DB 606 or a public database for recognizing the objects (resources). Engine 604 may be an AI-based object recognization system to identify faulty objects. The engine extracts prominent characteristics of the photo in the form of keywords which are used to generate search query 608. The search query 608 can be submitted as it is or can be enhanced to add context-awareness. Based on the query submitted, the searching module may return recommended set of results. FIG. 7 is an exemplary block diagram illustrating text or voice-based search feature in accordance with an embodiment of the present disclosure. A user can alternatively submit text or voice 702 input that can be processed by ML-based tex/voice search engine 704. Engine 704 processes the voice input using a combination of automatic speech recognition engines and natural language processing engines and create. The search query 708 can be submitted as it is or can be enhanced to add context-awareness. Based on the query submitted, the searching module may return recommended set of results. The searching module 502 returns the best-weighted search for the given home model, home interests, resident rating.

Users can also utilize a text/voice-based search function using natural language. The system may use Microsoft Azure AI speech, vision, and language services to transform raw, unstructured information into searchable content. Azure Cognitive Search may allow the searching module to select important keywords from the user's input to be used in conjunction with other search functions.

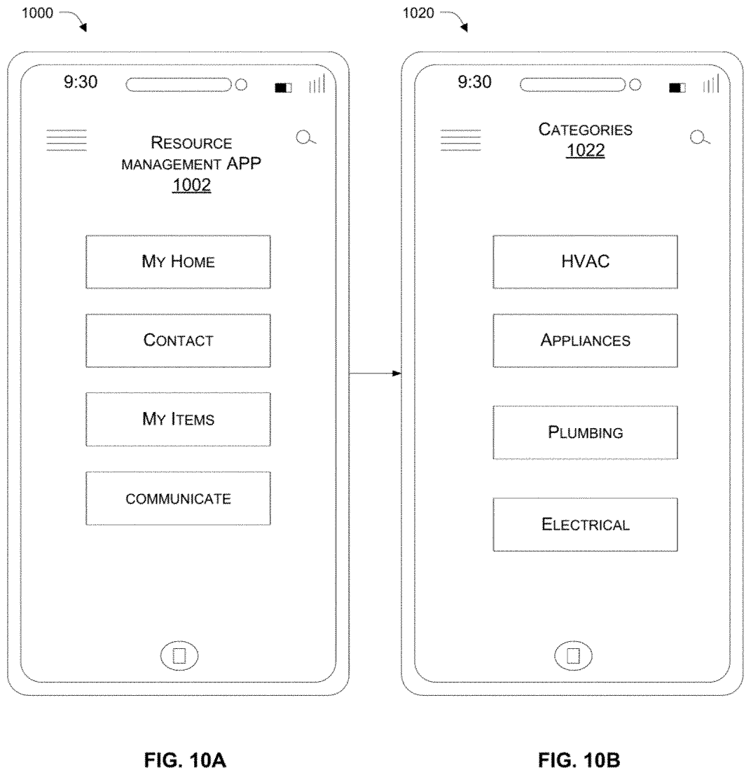

FIG. 8 illustrates an example feature list offered through a mobile application by the system to a user in accordance with an embodiment of the present disclosure. The proposed system allows users to connect through mobile Applications (APP). In an embodiment, interface 800 of the APP 802 may include options, such as home 804, contacts 806, cast 808, communicate 810, door unlock 812, community event 814, AR experience 816, and watch together experience 818. Home 804 presents resources associated with a home. The contacts 806 option presents contact details of different vendors categorized on the logical grouping and potential issue-wise. The cast 808 option allows a user to cast the screen to another detail so that others can see the issue, recommended solution, content, etc. The communicate 810 option allows users to communicate with a professional service provider or other users facing similar issues. The door unlocks 812 option allows the user to unlock the door from a remote location. The door unlock option can be used by a user in a situation where something needs to be fixed (e.g., a plumbing issue) in a home, but the user is not at home. Community event 814 can be used to create and participate in a community event. The community event 814 can be used to report an issue, which may have an impact on other homes having a similar profile or in the vicinity. The AR experience 816 allows different stakeholders (homeowner, real estate builder, service professional, etc.) to watch the issue and contents together. Using a QR code or smart tag, users can search for an item and initiate an AR experience. The system can add other stakeholders or send an invite to join the AR experience to explore the issue and help the user resolve it. QR codes and NFC tags can be associated with important resources within the home as well as the community for easy access to content regarding tips, resources, and related contacts. Use Your Phone to Take a Picture, Scan, or Tap (NFC) to Reveal Content. One can take a picture, scan or tap an NFC tag to get details of a home or home resources. Tags can be attached with a home or specific item of a home.

Similarly, the watch together experiences 818 allow a user and other stack holders to watch the issue in a 2D, 3D, or 360-degree environment.

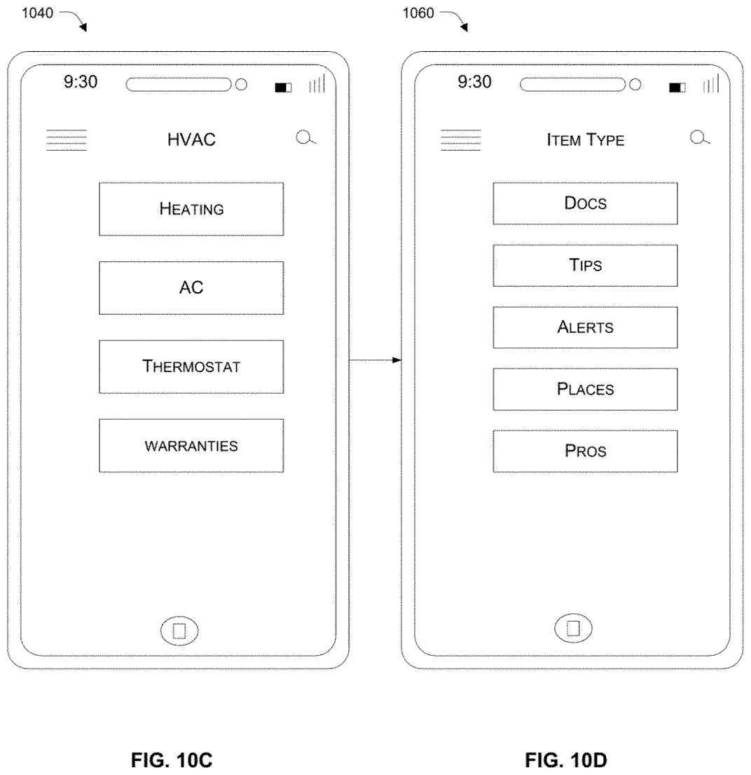

FIG. 9 is a flow diagram illustrating image-based interaction with the system in accordance with an embodiment of the present disclosure. A user can take a picture or read a tag associated with an item (also referred to as resource), as shown in block 902. The system can identify a resource that may have a potential issue from the scanned tag/picture, as shown at block 904, provide details associated with the resources as shown at block 906, show recommended content for the identified issue as shown at block 908, and allows user to save contact details/locality of the service professional or an option to navigate to professional service address as shown at block 910. The system allows users to cast his/her screen on the second device, as shown in block 912.

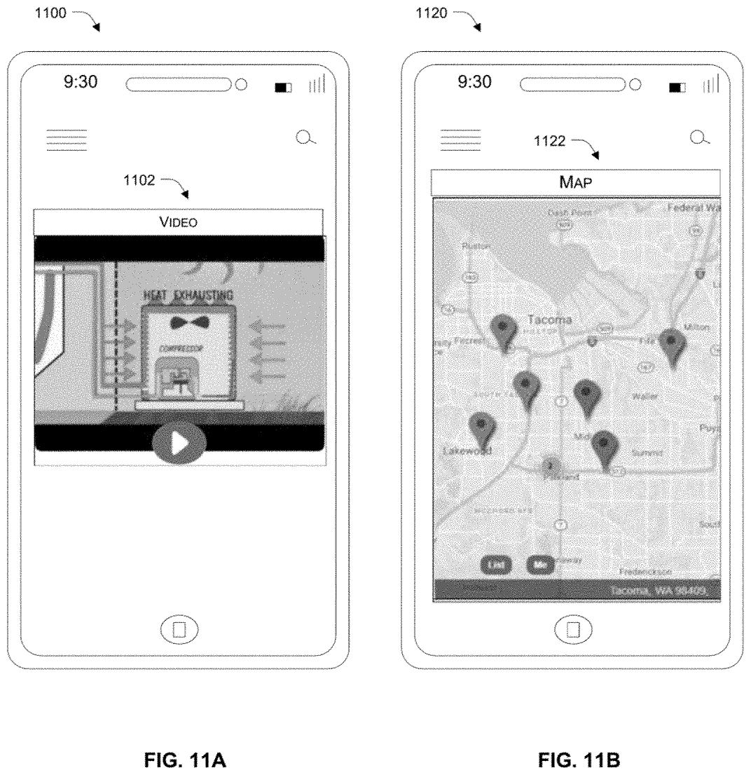

FIG. 10A is an example user interface illustrating a landing page for a mobile application in accordance with an embodiment of the present disclosure. The system support provides multiple options to find the right content. The system allows a user to connect through a resource management app 1002 that allows the user to see resources associated with a home, contacts, and personal items(My items). The App 1002 stores the resource/item details marked as personal items or my item in local storage and doesn't transmit data related to such items over a network. This ensures the privacy of user data. The proposed system will not collect data associated with such items unless requested by a user to identify any issue and resolve it.

FIG. 10B is an example user interface illustrating categories for selected entity types in accordance with an embodiment of the present disclosure. The general menu includes links to categories for each main feature of the home, along with its corresponding sub-features. When a user selects my home option in interface 1000, app 1002 may present categories 1022 to the user. The order of presentation of categories may be dynamically adjusted depending on the potential issue detected by the system. The example categories displayed on interface 1020 are for a home. The categories include HVAC, Appliances, plumbing, Electrical, etc. FIG. 10C is an example user interface illustrating a sub-category of resources in accordance with an embodiment of the present disclosure. The interface 1040 presents sub-categories for HVAC components. The HVAC sub-categories, for example, include a heating device, AC, Thermostat, etc. The interface may provide an option to explore warranties and other documents associated with any component/device/item/ resource. Similarly, a list of components/subsystems under each category can be presented.

FIG. 10D is an example user interface illustrating item types associated with a resource that a user can browse in accordance with an embodiment of the present disclosure. The system allows users to browse through the associated documents, present tips and alerts, and present places where the user's needs can be filled. Resources/Items under each of the categories can be added based on new purchase and sell transactions reported.

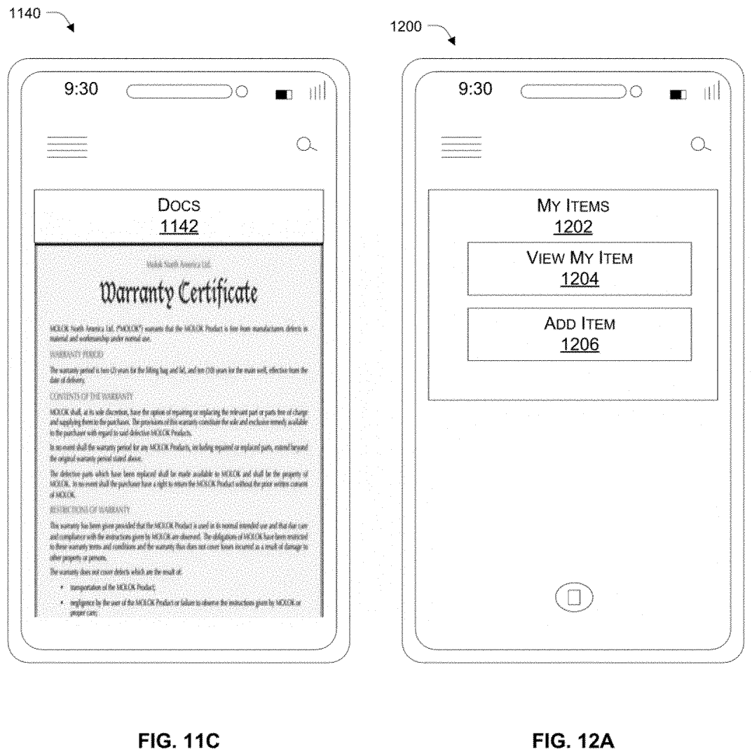

FIGS. 11A-11C are example user interfaces illustrating different content types that can be shown to the user in accordance with an embodiment of the present disclosure. Interface 1100 presents video content 1102 (e.g., do-it-yourself or professional repair help video) to the user that might help the user resolve an issue or get more detail about an item. Interface 1120 shows map 1122 with tagged places of interest where users can get help, and interface 1140 allows users to show documents 1142 (e.g., warranty certificate) or share the document with a service provider. When the menu is used by Users such as homeowners, the menu connects homeowners with home-specific documents, alerts, and web links added by the PRO distributors and/or Residents. Links to products, services, Do-it-Yourself videos, annotated video, annotated audio, annotated maps, and websites to professionals can be added by the different stack holders depending on their role.

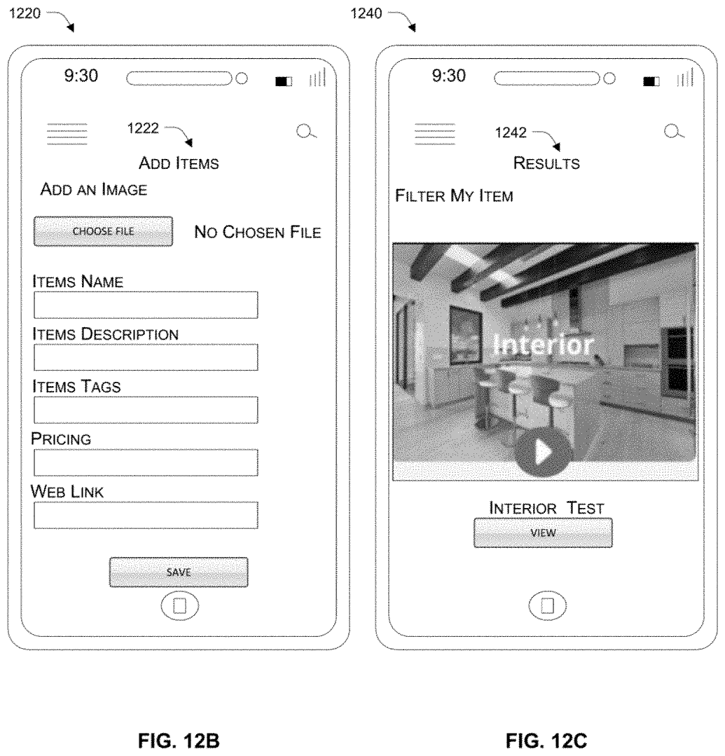

FIGS. 12A-C is an example user interface used to add details associated with a resource in accordance with an embodiment of the present disclosure. The interface 1200 allows users to maintain an updated list of items 1202. The user/professional distributor or service provider can view a list of existing items associated with a physical asset by selecting the option “view my item” 1204 and add a new item by selecting the option “add item” 1206. To add item 11222, the user can upload an image, assign a name to the item, add a description, add item tags, add price details, and weblink. The proposed system allows a user to, through an interface (e.g., Interface 1240) to watch the interior view of a house and select an object in more detail. The proposed system supports other 2D, 3D, AR, VR, and 360-degree video viewing experiences, where users can select an object by pausing a video and get more details. A user can add, manage and collect web links utilizing a white label. PRO distributors can bulk upload to the contents, which will be classified, categorized, and tagged with matching resources. Contents uploaded by different stakeholders can be targeted for an individual model and/or home. Items that can be added to Casalogy include websites, SoundCloud Audio, YouTube, LearnChurn items such as annotated Directories, Maps, and Photo Galleries.

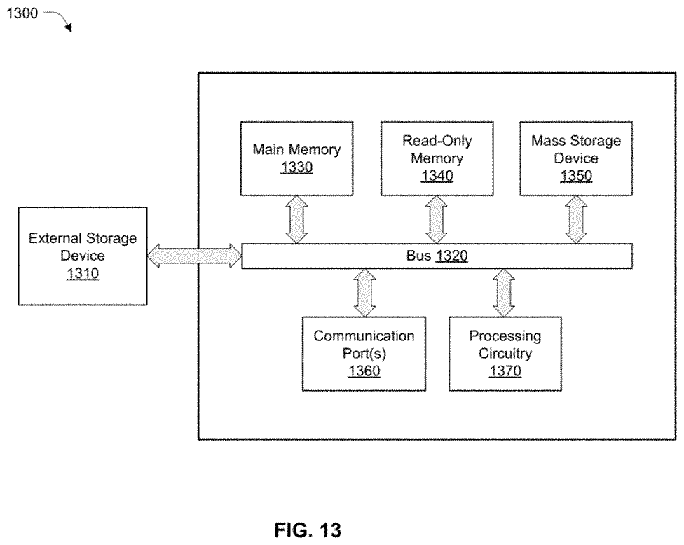

FIG. 13 illustrates an exemplary computer system in which or with which embodiments of the present invention may be utilized. Depending upon the particular implementation, the various process and decision blocks described above may be performed by hardware components, embodied in machine-executable instructions, which may be used to cause a general-purpose or special-purpose processor programmed with the instructions to perform the steps, or the steps may be performed by a combination of hardware, software, firmware and/or involvement of human participation/interaction. As shown in FIG. 13, the computer system includes an external storage device 1310, bus 1320, main memory 1330, read-only memory 1340, mass storage device 1350, communication port 1360, and processor 1370.

Those skilled in the art will appreciate computer system 1300 may include more than one processing circuitry 1370 and communication ports 1360. Processing circuitry 1370 should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quadcore, Hexa-core, or any suitable number of cores) or supercomputer. In some embodiments, processing circuitry 1370 is distributed across multiple separate processors or processing units, for example, multiple of the same type of processing units (e.g., two Intel Core i7 processors) or multiple different processors (e.g., an Intel Core i5 processor and an Intel Core i7 processor). Examples of processing circuitry 1370 include, but are not limited to, an Intel® Itanium® or Itanium 2 processor(s), or AMD® Opteron® or Athlon MP® processor(s), Motorola® lines of processors, System on Chip (SoC) processors or other future processors. Processing circuitry 1370 may include various modules associated with embodiments of the present invention.

Communication port 1360 may include a cable modem, integrated services digital network (ISDN) modem, a digital subscriber line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of electronic devices or communication of electronic devices in locations remote from each other. Communication port 1360 can be any RS-232 port for use with a modem-based dialup connection, a 10/100 Ethernet port, a Gigabit, or a 10 Gigabit port using copper or fiber, a serial port, a parallel port, or other existing or future ports. Communication port 1360 may be chosen depending on a network, such as a Local Area Network (LAN), Wide Area Network (WAN), or any network to which the computer system connects.

Memory 1330 may include Random Access Memory (RAM) or any other dynamic storage device commonly known in the art. Read-only memory 1340 can be any static storage device(s), e.g., but not limited to, a Programmable Read-Only Memory (PROM) chip for storing static information, e.g., start-up or BIOS instructions for processing circuitry 1370.

Mass storage 1350 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) 10 recorders, BLU-RAY 3D disc recorders, digital video recorders (DVRs, sometimes called a personal video recorder or PVRs), solid-state devices, quantum storage devices, gaming consoles, gaming media, or any other suitable fixed or removable storage devices, and/or any combination of the same. The non-volatile memory may also be used (e.g., to launch a boot-up routine and other instructions). Cloud-based storage may be used to supplement storage memory in 1330. Memory 1350 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firmware interfaces), e.g., those available from Seagate (e.g., the Seagate Barracuda 7200 family) or Hitachi (e.g., the Hitachi Deskstar 7K1000), one or more optical discs, Redundant Array of Independent Disks (RAID) storage, e.g., an array of disks (e.g., SATA arrays), available from various vendors including Dot Hill Systems Corp., LaCie, Nexsan Technologies, Inc. and Enhance Technology, Inc.

Bus 1320 communicatively couples processor(s) 1370 with the other memory, storage, and communication blocks. Bus 1320 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 1370 to a software system.

Optionally, operator and administrative interfaces, e.g., a display, keyboard, and a cursor control device, may also be coupled to bus 1320 to support direct operator interaction with computer systems. Other operator and administrative interfaces can be provided through network connections connected through communication port 1360. An external storage device 1210 can be any kind of external hard-drives, floppy drives, IOMEGA® Zip Drives, Compact Disc-Read-Only Memory (CD-ROM), Compact Disc-Rewritable (CD-RW), Digital Video Disk-Read Only Memory (DVD-ROM). The components described above are meant only to exemplify various possibilities. In no way should the aforementioned exemplary computer system limit the scope of the present disclosure.

The computer system 1300 may be accessed through a user interface. The user interface application may be implemented using any suitable architecture. For example, it may be a stand-alone application wholly implemented on the computer system 1300. The user interfaces application and/or any instructions for performing any of the embodiments discussed herein may be encoded on computer-readable media. Computer-readable media includes any media capable of storing data. In some embodiments, the user interface application is a client server-based application. Data for use by a thick or thin client implemented on an electronic device computer system 1300 is retrieved on-demand by issuing requests to a server remote to the computer system 1300. For example, computer device 1300 may receive inputs from the user via an input interface and transmit those inputs to the remote server for processing and generating the corresponding outputs. The generated output is then transmitted to the computer device 1300 for presentation to the user.

While embodiments of the present invention have been illustrated and described, it will be clear that the invention is not limited to these embodiments only. Numerous modifications, changes, variations, substitutions, and equivalents will be apparent to those skilled in the art without departing from the spirit and scope of the invention, as described in the claims.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document, terms “coupled to” and “coupled with” are also used euphemistically to mean “communicatively coupled with” over a network, where two or more devices are able to exchange data with each other over the network, possibly via one or more intermediary devices.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C, and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded to the widest scope consistent with the principles and novel features disclosed herein. It is contemplated that additional embodiments are within the spirit and true scope of the disclosed subject matter.

I claim:

1. I claim all of the above subject matter.
